(19) United States
(12) Patent Application Publication
(10) Pub. No.: US 2004/0227963 A1
(43) Pub. Date: Nov. 18, 2004

(54) Introducing loss directly on display list data

(76) Inventors: Dana A. Jacobsen, Boise, ID (US); Terry-Lee M. Fritz, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/437,845

(22) Filed: May 14, 2003

(51) Int. Cl. H04N 1/64; H04N 1/60; H04N 1/21

(52) U.S. Cl. 358/1.9; 358/518; 358/539; 345/605; 358/1.16; 358/524

(57) ABSTRACT

A system and methods introduce loss directly on display list commands. Various methods are described for introducing loss directly on display list color commands and on display list vector commands. Advantages of the disclosed system and methods include significant savings in printer memory with only subtle loss being introduced to printed images.

### TECHNICAL FIELD

The present disclosure generally relates to printing, and more particularly, to saving memory space in a printer by introducing loss directly on display list data.

### BACKGROUND

A typical printing environment includes a source or host device, such as a computer, that provides image or object information in the form of print data to a printing device. Exemplary printing devices may include, for example, a laser printer, an ink jet printer, a thermal printer, a facsimile device, a copier and so on. Such devices generally require increasing amounts of memory to process the print data from source devices. However, because memory space on most printing devices is somewhat limited, various methods have been devised for saving memory while processing print data.

A host computer typically provides a printing device with pages that are formatted in a page description language (PDL) such as Postscript or Printer Control Language (PCL). The printing device parses and renders the PDL to form an image of a page that is suitable for the type of print engine being used. During the formatting of a page, a description of the page (i.e., in a PDL) received from a host is converted into a series of simple commands or “objects” that describe what will be printed. The objects are parsed and sorted according to their vertical position on the page. The page is logically divided into sections called strips. The strips are then individually rendered (i.e. the described objects in the strips are rendered) into a raster image that is passed to the print engine for printing. While horizontal strips are discussed here, vertical strips or other tilings of the page can also be used.

Dividing a page into a plurality of strips enables lesser amounts of RAM to be used for the print image than would otherwise be required if all the objects on a page were to be rendered at the same time and stored in RAM as bit map data (i.e., raster data). This procedure therefore provides a more economical way to render object data from PDL drawing commands. Conventional printers usually divide a page into about 50 to about 100 page strips, each of which is defined by an associated display list. The display list is directed only to those objects that fall within the respective strip. The simple objects in a strip are decomposed from more complex PDL objects. The display list includes commands or operational codes (opcodes) generated from parsing the PDL drawing commands. Display list commands identify objects and provide information necessary about the objects, such as their size and color. For example, a rectangle object might be identified as a “rectangle” followed by X and Y coordinates, a width measurement, and a height measurement. Display lists having such commands parsed from PDL commands can be relatively compact in size. Thus, the amount of printer memory required to process the print data is reduced.

Once a display list has been generated for a page strip, a rendering process renders the page strip as raster data directly to a print engine or into memory for temporary buffering or compression. For printers that render the strips into memory, the amount of memory required is substantially reduced when compared to rendering a whole page and storing it in RAM as raster data. For example, if there are 50 strips in a page, then a printer needs rendering storage for only about 1/50 the amount of memory than that needed to render and store a whole page.

Although rendering a page as a plurality of strips reduces the amount of memory required to process the page, the need to further reduce memory requirements remains. Various methods have been developed to save memory while processing print data. One method is to apply lossy compression to raster data. Lossy compression is typically applied to rendered strips, but if memory is depleted prior to rendering, this method will not allow continued processing. Lossy compression has also been applied to intermediate raster which will save memory while processing print data but sometimes does not save enough memory to allow continued processing. In the case of pages with no raster data, such as complex vector graphics pages, this compression method will not save any memory.

Accordingly, the need exists for improved ways to process print data that will increase memory savings.

### SUMMARY

A system and methods introduce loss directly on commands in a display list.

In one implementation, various methods are used to introduce loss into display list color commands. In another implementation, various methods are used to introduce loss into display list vector commands.

### BRIEF DESCRIPTION OF THE DRAWINGS

The same reference numbers are used throughout the drawings to reference like components and features.

FIG. 1 illustrates an embodiment of an exemplary environment that is suitable for introducing loss directly on commands in a display list.

FIG. 2 is a block diagram showing one embodiment of a hardware/software architecture for an input device and a printing device as might be implemented in the exemplary environment of FIG. 1.

FIG. 3 is a flow diagram that describes an embodiment of a method for saving memory on a printing device by introducing loss directly on commands in a display list.

FIG. 4 is a flow diagram that describes another embodiment of a method for saving memory on a printing device by introducing loss directly on commands in a display list.

FIGS. 5 through 8 are flow diagrams that describe embodiments of methods for introducing loss directly into display list color commands.

FIGS. 9 through 13 are flow diagrams that describe embodiments of methods for introducing loss directly into display list vector commands.

### DETAILED DESCRIPTION

### Overview

The following discussion is directed to a system and methods for encoding (i.e., introducing) loss directly in display list commands. Loss is encoded into display list color commands and display list vector commands. Advantages of the disclosed system and methods include significant savings in printer memory with only subtle loss to printed images.

### Exemplary Environment

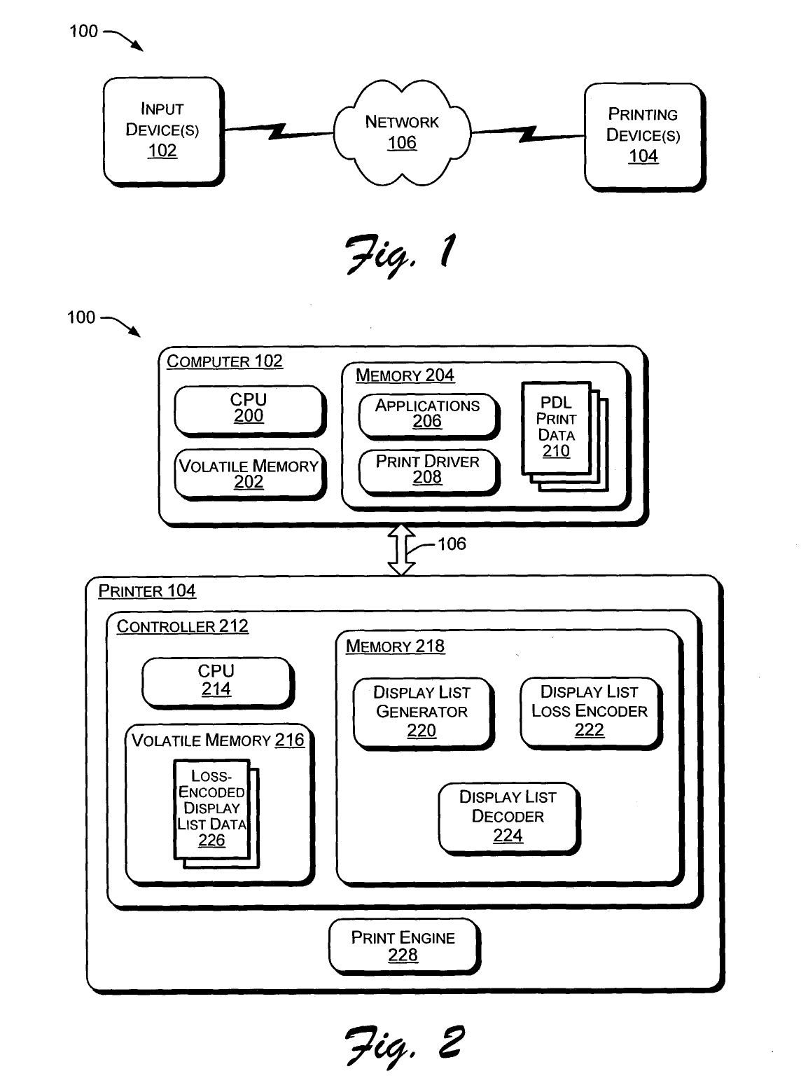

FIG. 1 shows an embodiment of an exemplary system environment 100 suitable for implementing various methods that selectively encode loss on display list commands. In general, encoding loss into display list commands reduces the precision of the information represented in the commands. More specifically, encoding loss into display list commands reduces the number of digital bits used to store the display list commands, thereby reducing the amount of memory necessary to store display list data. Loss can be encoded (i.e., introduced) into display list color commands, vector commands, or both.

The exemplary environment 100 includes input device(s) 102 and printing device(s) 104 operatively coupled through a network 106. The network 106 can include both local and remote connections depending on the particular system configuration. Thus, network 106 may include, for example, a printer cable, a LAN (local area network), a WAN (wide area network), an intranet, the Internet, or any other suitable communication link. Network connection 106 might also include a wireless communications link such as an IR (infrared) or RF (radio frequency) link.

Input device(s) 102 can be implemented as a variety of general purpose computing devices including, for example, a personal computer (PC), a laptop computer, a handheld PDA (e.g., Palmtop, PalmPilot), a Macintosh, a workstation computer, and other devices configured to communicate with printing device(s) 104. An input device 102 typically provides a user with the ability to manipulate or otherwise prepare in electronic form, an image or document that can be rendered as an image to be printed or otherwise formed in hardcopy on a print medium by a printing device 104 after transmission over network 106.

In general, an input device 102 outputs formatted print data to a printing device 104 which converts the data and outputs it onto an appropriate recording media, such as paper or transparencies. Print data from input device 102 is generally formatted by a printer driver into a PDL (page description language) format suitable for printing device 104, such as PCL (Printer Control Language) or PostScript, prior to being sent to printing device 104.

Printing device(s) 104 can be implemented as various types of printers capable of rendering PDL data in printed form on a print medium, such as printing pixels on paper. Therefore, printing device(s) 104 can include devices such as laser-based printers, ink-based printers, dot matrix printers, dry medium printers, plotters and the like. In addition, printing device(s) 104 might also include various multi-function peripheral (MFP) devices that combine a printing function with other functions such as facsimile transmission, scanning, copying and the like.

### Exemplary Hardware/Software Architecture

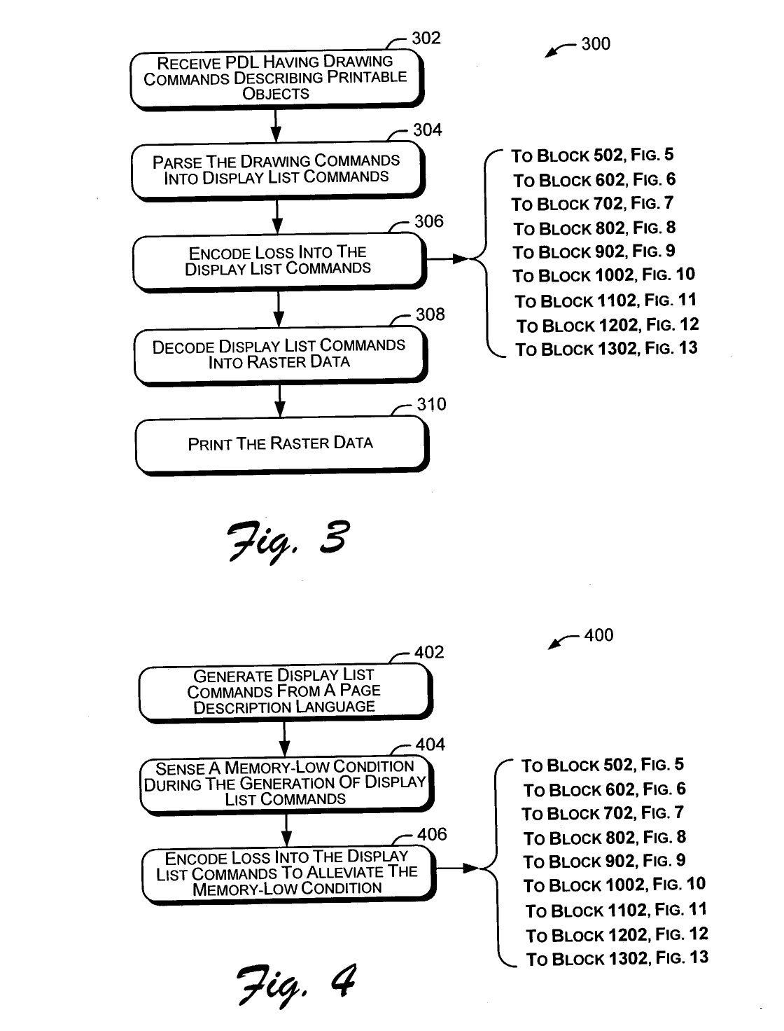

FIG. 2 is a block diagram illustrating an exemplary embodiment of an input device 102 and a printing device 104 as might be implemented in the system environment 100 of FIG. 1. Input device 102 is embodied as computer 102. Printing device 104 is embodied as printer 104.

Computer 102 typically includes a processor 200, a volatile memory 202 (i.e., RAM), and a nonvolatile memory 204 (e.g., ROM, hard disk, floppy disk, CD-ROM, etc.). Nonvolatile memory 204 generally provides storage of computer/processor-readable instructions, data structures, program modules and other data for computer 102. Computer 102 may implement various application programs 206 stored in memory 204 and executable on processor 200 to create or otherwise form a document or image (e.g., text and graphics) on a computer screen that is transferable over network 106 to printer 104 for creating a hard copy of the document/image. Such applications 206 might include software programs implementing, for example, word processors, spread sheets, browsers, multimedia players, illustrators, computer-aided design tools and the like.

Computer 102 also typically implements one or more software-based device drivers such as print driver 208 that are stored in nonvolatile memory 204 and executable on processor 200. Device drivers might also be implemented on the specific devices they are “driving”, such as printer 104. In general, print driver 208 receives print data from an application program 206 in an application format and translates it into a printer-friendly format (i.e., a PDL 210) such as PostScript, PCL, or another appropriate format. The PDL formatted print data 210 is then output to printer 104 where it is rendered and output in hardcopy form onto a print medium such as paper or transparencies.

Printer 104 includes controller 212 that, in general, processes data from computer 102 to control the output of printer 104 through print engine 228. Controller 212 includes a processing unit or CPU 214, a volatile memory 216 (i.e., RAM), and a nonvolatile memory 218. Nonvolatile memory 218 can include various computer storage media such as ROM, flash memory, a hard disk, a removable floppy disk, a removable optical disk and the like. Nonvolatile memory 218 generally provides storage of computer/processor-readable instructions, data structures, program modules and other data for printer 104. Accordingly, nonvolatile memory 218 includes a display list generator 220, a display list loss encoder 222, and a display list decoder 224. These components are implemented in software as computer/processor-executable instructions that can be executed on processor 214.

Display list generator 220 is configured to receive PDL print data 210 from computer 102 and to generate display lists from PDL drawing commands within the print data 210. Display list generator 220 parses PDL drawing commands that describe complex objects on a page into display list commands that describe less complex objects within a small strip of the page. Thus, each page strip has a display list that describes the objects that fall within that strip. A display list includes commands or operation codes (opcodes) generated from parsing the PDL drawing commands. Display list commands include color commands and vector commands that identify objects and provide information necessary about the objects, such as their size and color. For example, a display list vector command may include an opcode identifying a “rectangle”, followed by parameters that define the rectangle's width, height, and top left corner in X and Y coordinates. A display list color command may define the rectangle's color in a 24 bit RGB (red, green blue) color space. A display list typically comprises these color commands, vector commands, and other commands such as those representing raster, fonts, and other objects and states. Many different types of display lists and commands are possible and the embodiments described are not intended to be limiting.

Display list loss encoder 222 is configured to encode loss directly into display list color commands and/or display list vector commands generated by display list generator 220. Accordingly, volatile memory 216 of FIG. 2 also includes loss-encoded display list data 226. Loss-encoded display list data 226 is intended to represent display lists having display list commands (e.g., color commands and/or vector commands) that have been encoded with loss by encoder 222. Display list loss encoder 222 may employ various methods to encode loss into color and vector commands. Several methods for encoding loss into display list color and vector commands are discussed below.

Display list loss encoder 222 may apply loss to display list commands at various points during the processing of PDL print data 210 from computer 102. For example, loss may be encoded into display list commands as display list generator 220 generates the commands from the PDL print data 210. Loss might also be encoded into display list commands just before the commands are about to be stored on a display list. Loss might also be encoded into display list commands as a function of a processing event. An example of a processing event that might initiate the encoding of loss into display list commands is a “memory low” condition. During the generation of display lists by display list generator 220, printer 104 might sense a memory low condition that indicates memory will be depleted prior to the successful storage of a complete page of PDL print data 210 in display list format. In order to circumvent the depletion of memory, display list loss encoder 222 would encode loss into previously coded color commands and/or vector commands already stored on display lists. Loss encoder 222 might also encode loss into all subsequently generated display list commands. Encoding loss into display list commands in this manner reduces the amount of memory space needed to store the display lists representing the page of PDL print data 210, thus reducing the possibility that the printer 104 might generate an error message such as, “Out of memory, page cannot be printed”.

Display list decoder 224 is generally configured to decode display list data, including loss-encoded display list data 226. Decoder 224 decodes loss-encoded display list data 226 into raster data that is used to drive print engine 228. Display list decoder 224 uniquely interprets the specific format of the loss-encoded display list data 226 from display list generator 220 and loss encoder 222. Depending on the method used to introduce loss by the loss encoder 222, the display list decoder 224 may be unchanged from a traditional decoder.

### Exemplary Methods

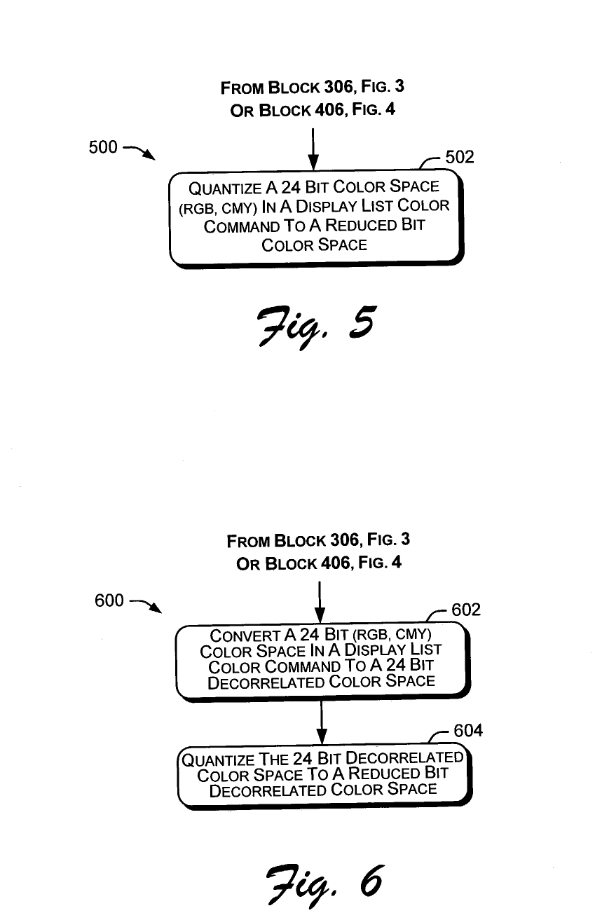

Various exemplary methods for saving memory on a printing device through encoding loss into display list commands will now be described with primary reference to the flow diagrams of FIGS. 3 through 13. The methods apply generally to the exemplary embodiment discussed above with respect to FIGS. 1 and 2. The elements of the described methods may be performed by any appropriate means, such as by the execution of processor-readable instructions defined on processor-readable media, such as a disk, a ROM or other such memory device.

FIG. 3 shows an embodiment of an exemplary method 300 for saving memory on a printing device 104. At block 302 of method 300, a printer 104 receives PDL print data 210 from an input device such as computer 102 (FIG. 2). The PDL print data 210 is typically in a page description language (PDL) format such as Postscript or Printer Control Language (PCL). The PDL print data 210 includes drawing commands that describe objects such as text, graphics, and photographs that are to be printed on a page.

At block 304 of method 300, the drawing commands in the PDL print data 210 are parsed into display list commands. The display list generator 220 on printer 104 breaks up a page of complex objects described by the PDL print data 210 into simpler objects occupying small strips of the page. The display list generator 220 generates display list commands that describe the simple objects within each strip. Thus, each strip has a corresponding display list of commands.

It is generally well-known to those skilled in the art that display list commands include color commands and vector commands. Typical display list commands include opcodes and parameters. Opcodes direct how parameters are to be interpreted. For example, a display list vector command may have a trapezoid opcode that directs that seven subsequent parameters should be interpreted as follows:

1) X coordinate for top left point of trapezoid;

2) Y coordinate for top left point of trapezoid;

3) X coordinate for top right point of trapezoid;

4) Y coordinate for top right point of trapezoid;

5) Slope of left side of trapezoid;

6) Slope of right side of trapezoid;

7) Height.

Each parameter is typically represented by a number of bits in a digital representation. Therefore, a trapezoid opcode could be followed by seven, 8 bit parameters that may appear, for purposes of illustration, as follows:

Trapezoid: 00000001, 00000010, 01100001, 10101000, 11110000, 11001100, 10101010

It is noted that this bit representation is used merely by way of example, and that the number of bits representing object parameters is typically quite different. For example, there may typically be 12-16 bits representing X-Y coordinates, 8-12 bits representing slopes, and 6-16 bits representing height.

In a similar manner, a display list color command may include an opcode that directs, for example, that three subsequent parameters should be interpreted to describe each color component in a 24 bit encoded RGB (red, green, blue) color space as follows:

RGB: 00100100, 00001101, 11100011

A color space, such as RGB, is a specific way of representing colors as tuples of numbers, typically as three or four values. Color spaces lend themselves to reproducible representations of color, particularly in digital representations, such as digital printing or digital electronic display.

Accordingly, display list color commands are often represented in a 24 bit encoded RGB color space having an 8 bit, 8 bit, 8 bit coding such as shown above. That is, each component of the RGB color space is represented by an 8 bit digital value, which represents a color component value from zero to 255. For example, the 8 bit representation of the Red color component (i.e., 00100100) in the above representation sets the Red component value at 36.

Representing color space in various forms is well-known to those skilled in the art. In general, the color space used to represent a digital image is dictated by how the image is acquired or by the intended use for the image. RGB is a basic color image format that is readily suitable for use with devices such as monitors, color scanners, video cameras, and the like. Such devices incorporate three sensors that are spectrally sensitive to light in the red, green, and blue portions of the spectrum. The three separate red, green, and blue values can be made to directly drive red, green, and blue light guns in a CRT. This type of color system is called an additive RGB color system, as the sum of the three full color values produces white.

There are many forms for representing color space however, and display list color commands are not necessarily limited to an RGB color space representation. They may use, for example, a 24 bit CMY (cyan, magenta, yellow) color space representation. CMY is a subtractive color process often used with printed color images where cyan, magenta, and yellow dyes or pigments are deposited onto paper. The amount of dye deposited is subtractively proportional to the amount of each red, blue, and green color value. The sum of the three full CMY color values produces black. CMYK is another color space commonly used in printers where black is added to CMY.

Referring again to block 304 of method 300, the display list generator 220 generates display list vector commands describing simple objects within each page strip, while also generating display list color commands as appropriate to control the color of the objects.

Continuing with method 300 of FIG. 3, at block 306, loss is encoded directly into the display list commands by display list loss encoder 222 (FIG. 2). In general, encoding loss into display list commands reduces the precision of the information represented in the commands. More specifically, encoding loss into display list commands reduces the number of digital bits used to store the display list commands, thereby reducing the amount of memory necessary to store display list data (e.g., loss-encoded display list data 226 of FIG. 2).

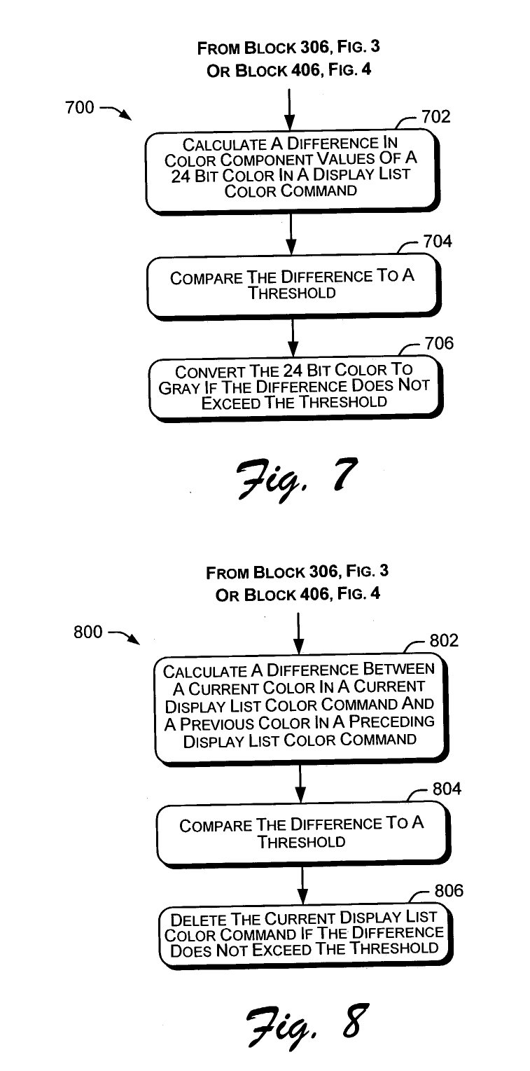

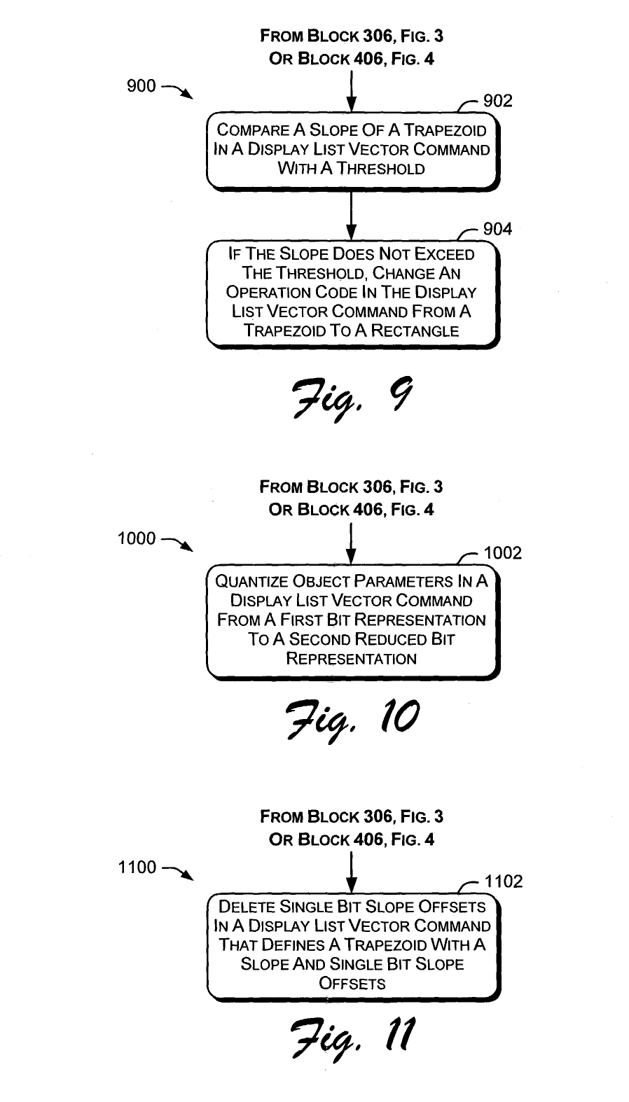

Loss can be encoded (i.e., introduced) into display list color commands, vector commands, or both, through various methods such as those described below with respect to FIGS. 5 through 13. Block 306 of FIG. 3 points to the first element of each of the various methods to illustrate that each of these methods is one way in which loss may be encoded into display list commands. In addition to various methods for encoding loss, the loss can be encoded into display list commands at different times during the processing of PDL print data 210 from computer 102. For example, loss may be encoded into display list commands while the display list generator 220 generates the display list commands from the PDL print data 210. Loss might also be encoded into display list commands just before the commands are to be stored on a display list. Furthermore, a processing event might also initiate the introduction of loss into display list commands, as discussed below with respect to the method of FIG. 4.

Continuing with method 300, at block 308, loss-encoded display list data 226 (FIG. 2) is decoded into raster data. Decoding the loss-encoded display list data 226 often involves reversing the method of loss encoding performed by the display list loss encoder 222 (e.g., reversing methods described below with respect to FIGS. 5 through 13). At block 310, the raster data is printed. For example, in an electrophotographic print process, printing includes driving the print engine 228 with the decoded raster data, developing printable objects on a photoconductive surface, and rendering the objects in hardcopy form on a recording medium.

FIG. 4 shows another embodiment of an exemplary method 400 for saving memory on a printing device 104 through encoding loss directly into display list commands. The method 400 illustrates an example of a processing event that triggers the introduction/encoding of loss into display list commands. At block 402 of method 400, display list commands are generated from PDL print data 210 in a manner such as that described above with respect to block 304 of FIG. 3.

During the generation of the display list commands by display list generator 220 (FIG. 2), a “memory-low” condition may arise as illustrated at block 404. A memory-low condition is an example of an event that may occur during the processing of PDL print data 210 into display list commands that indicates memory may be depleted prior to the successful storage of the display list commands (i.e., display lists) that represent a complete page of PDL print data 210. Therefore, a memory-low condition sensed by a printer 104 at block 404 can be used to initiate the encoding of loss into the display list commands in order to alleviate the memory-low condition, as shown in block 406.

Display list loss encoder 222 (FIG. 2) may encode loss into display list commands generated subsequent to the memory-low warning, or it may retroactively encode loss into previously coded display list commands (color commands and/or vector commands) already stored on display lists. Or, it may encode loss into all of the display list commands. Loss-encoded display list data 226 is intended to generally represent display lists having display list commands that have been encoded with loss. Encoding loss into display list commands in this manner reduces the amount of memory space needed to store the display lists that represent a page of PDL print data 210, thus reducing the possibility that the printer 104 might generate an error message such as, “Out of memory, page cannot be printed”.

Like block 306 of FIG. 3 described above, block 406 of method 400 points to the first element of each of the various methods of FIGS. 5 through 13 to illustrate that each of these methods is one way in which loss may be encoded into display list commands.

FIG. 5 shows an embodiment of an exemplary method 500 for encoding loss into a display list color command. The method 500 is generally performed by the display list loss encoder 222 (FIG. 2), and may be considered to be an extension of either of the methods 300 and 400 from FIGS. 3 and 4, respectively. At block 502 of method 500, a 24 bit color space from a display list color command is quantized into a reduced bit color space. The initial 24 bit color space in the display list color command is typically a 24 bit RGB (red, green, blue) color space having an 8 bit, 8 bit, 8 bit coding, where each component of the RGB color space is represented by an 8 bit digital value that sets the color component value from zero to 255.

Quantizing a 24 bit RGB color space to a reduced bit color space as shown in block 502, reduces the number of bits used to represent each color component value. The quantization is typically a linear reduction, but can also be a nonlinear reduction. An simple example of a linear quantization would be to divide the 8 bit representation of each color component by 2. This linear quantization would result in each component of the RGB color space being represented by 7 bits instead of 8 bits, thus reducing the amount of memory needed for storage of a display list color command by 3 bits.

Depending on the original value of each color component, the reduction may result in some loss of precision with respect to the color that is produced by a printer 104. For example, if a red color component value is 201, its 8 bit digital representation is 11001001. Quantizing the 201 value by dividing by 2 results in the value 100.5. The 7 bit digital representation of 100.5 drops the non-whole number portion (i.e., the 0.5 is dropped). Thus, 100.5 is represented by 7 bits as 1100100. Storing the 7 bit representation rather than the 8 bit representation saves memory space. When display list decoder 224 decodes the display list data 226, this red color component value is restored by reversing the quantization process and multiplying the 7 bit data by 2. The result is a red color component value of 200. Therefore, instead of a red color component value of 201 being printed by print engine 228, the value of 200 is printed. Thus, some precision may be lost in the quantization in order to save memory space.

Another example of quantizing a 24 bit RGB color space to a reduced bit color space as shown in block 502, is one that reduces the number of bits representing each color component value in varying ways that are consistent with how colors are perceived by the human eye. That is, more loss may be acceptable regarding one color component than with another color component. For example, 24 bits of color in an RGB color space may be linearly quantized so that 5 bits are used to represent both the red and blue components, while 6 bits represents the green component. This RGB coding of 5, 6, 5, as compared to the initial coding of 8, 8, 8, saves 8 bits of memory space each time a display list color command is stored. Alternatives include other coding combinations such as 6, 7, 4 coding. Such coding also applies to other color forms such as CMY (cyan, magenta, yellow).

Other examples of quantizing a 24 bit RGB color space to a reduced bit color space as shown in block 502 include nonlinear quantization methods. Such nonlinear quantization methods quantize the colors in varying ways that are more consistent with how colors are perceived by the human eye. More loss may be acceptable in one luminance range (e.g. dark areas) than another (e.g. bright areas). For example, 24 bits of color in an RGB color space may be converted to a logarithmic or gamma encoded space before quantizing according to one of the previous examples. This has the property of producing visually uniform loss when using fewer bits for coding, making the loss less visible.

FIG. 6 shows another embodiment of an exemplary method 600 for encoding loss into a display list color command. The method 600 is generally performed by the display list loss encoder 222 (FIG. 2), and may be considered to be an extension of either of the methods 300 and 400 from FIGS. 3 and 4, respectively. At block 602 of method 600, a 24 bit color space (e.g., an RGB or CMY color space) from a display list color command is converted to a 24 bit decorrelated color space such as a YCC, YIQ, YUV, Lab, or Luv color space. A decorrelated color space has the property of decorrelating the image data between planes. At block 604, the 24 bit decorrelated color space is quantized to a reduced bit color space in a manner similar to that described above with respect to method 500 of FIG. 5.

Converting to a decorrelated color space such as YCC (luminance, red chrominance, blue chrominance) prior to quantizing may permit a further reduction in the number of bits needed to represent a color in a display list color command, while at the same time, maintaining similar image quality relative to an RGB or CMY color space. Thus, a greater savings in printer 104 memory can be realized without an additional sacrifice to image quality. Characteristics of human visual perception and of the YCC color space in general, make such a benefit possible. The human visual system has much less dynamic range (acuity) for spatial variation in color than for brightness (luminance). Thus, humans are acutely aware of changes in the brightness of details as compared to small changes in hue. Therefore, rather than saving color as RGB, it can be more efficient to encode luminance in one channel and color information (that has had the luminance contribution removed) in two other channels. The two color channels can be encoded with less bandwidth by using a number of techniques, predominantly by reducing the precision, or by reducing the spatial resolution. Since green dominates the luminance (i.e., “Y”) channel, the two chrominance channels (i.e., “Cr” and “Cb”) are based on luminance-subtracted red and blue. Such luminance, red chrominance and blue chrominance systems are therefore generally referred to as Y, Cr, and Cb, or simply as YCC.

Thus, upon converting a 24 bit RGB or CMY color space in a display list color command to a 24 bit YCC (luminance, red chrominance, blue chrominance) color space (e.g., at block 602 of method 600), the 24 bit YCC color space is quantized to further reduce the number of bits to represent the YCC color (e.g., at block 604 of method 600). Quantizing a 24 bit YCC color space preferably reduces the number of bits that represent each component value or channel of the YCC color in varying ways that are consistent with how colors are perceived by the human eye. Typical examples include a YCC color space with a 7 bit, 5 bit, 3 bit coding or a 7 bit, 5 bit, 5 bit coding. These coding schemes emphasize the luminance (i.e., “Y”) channel of the YCC channel over the two chrominance channels.

FIG. 7 shows another embodiment of an exemplary method 700 for encoding loss into a display list color command. The method 700 is generally performed by the display list loss encoder 222 (FIG. 2), and may be considered to be an extension of either of the methods 300 and 400 from FIGS. 3 and 4, respectively. The method is generally intended to save memory space in a printer 104 by converting colors that appear to be close to a gray into a gray value. The conversion permits storage of an 8 bit gray scale value rather than a 24 bit color representation.

At block 702 of method 700, loss encoder 222 calculates a difference between color component values in a 24 bit encoded color, such as an RGB or CMY color. The calculation determines how far each color component is away from the other color components. For example, in a 24 bit encoded RGB color space, the red component may have a value of 201 (i.e., the 8 bit digital representation is 11001001). The green component may have a value of 202. The blue component may have a value of 200. Thus, the difference between each color component is a value of 1.

At block 704, the difference calculated in block 702 is compared to a threshold value. If the difference does not exceed the threshold value, then the 24 bit color is converted to a gray scale value represented by an 8 bit representation, as shown at block 706. Otherwise the 24 bit color is not converted, but is left in its initial form. It is understood that other metrics for determining the distance from the current RGB color to a gray value can be used. The calculation illustrated by the method 700 of FIG. 7 is simply one example and is not meant to be limiting.

FIG. 8 shows yet another embodiment of an exemplary method 800 for encoding loss into a display list color command. The method 800 is generally performed by the display list loss encoder 222 (FIG. 2), and may be considered to be an extension of either of the methods 300 and 400 from FIGS. 3 and 4, respectively. The method 800 is generally intended to save memory space in a printer 104 by deleting display list color commands that make only small changes in colors. Deleting such color commands has little or no perceivable impact on printed image quality, but may significantly reduce the amount of memory space required to store display list commands.

At block 802 of method 800, the difference between a current color in a current display list color command and a previous color in a previous display list color command is calculated. The previous color is the active color in the display list until it is changed by a current color. Thus, unless a previous (i.e., active) color is changed by a current color command, objects are rendered based on the previous color that is set by the previous color command. Display list loss encoder 222 calculates an average color for both the current color and the previous color based on the color components of a 24 bit RGB color, for example. At block 804, the difference is compared to a threshold value. If the difference between the previous (i.e., active) color and the current color does not exceed the threshold, then the current display list color command is deleted, as shown at block 806. Many metrics exist for determining the distance between two colors, including simple techniques such as the one shown here, or complicated techniques such as delta-E known to those skilled in the art. The calculation shown for determining the difference between the active color and the current color is meant as an example as is not intended to be limiting.

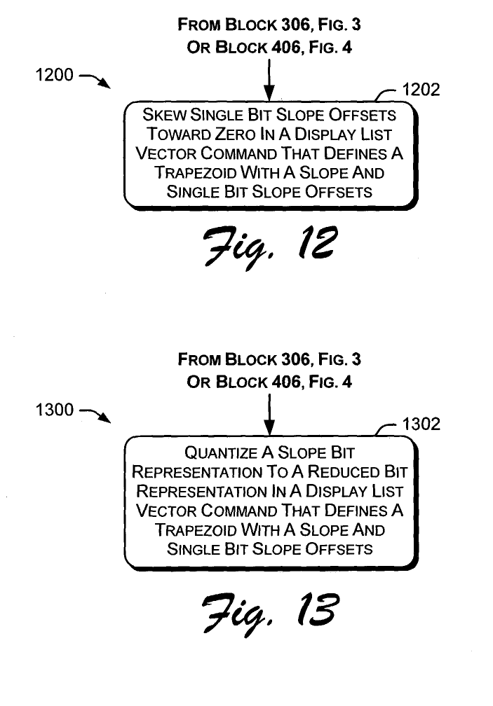

FIG. 9 shows an embodiment of an exemplary method 900 for encoding loss into a display list vector command. The method 900 is generally performed by the display list loss encoder 222 (FIG. 2), and may be considered to be an extension of either of the methods 300 and 400 from FIGS. 3 and 4, respectively. The method 900 is generally intended to save memory space in a printer 104 by reducing the number of stored parameters required to describe a display list object. When a trapezoid object is very close to a rectangle object, the trapezoid object is converted to a rectangle, thus reducing the number of parameters describing the object. Such a conversion has little or no perceivable impact on printed image quality, but may significantly reduce the amount of memory space required to store display list commands.

At block 902 of method 900, the slope of a trapezoid object in a display list vector command is compared to a threshold value. If the slope does not exceed the threshold, an opcode identifying the object as a trapezoid is changed or converted to an opcode that identifies the object as a rectangle. As discussed above, a trapezoid can be defined within a display list vector command with an opcode followed by seven parameters (each having an 8 bit digital representation) interpreted generally as follows:

1) X coordinate for top left point of trapezoid;

2) Y coordinate for top left point of trapezoid;

3) X coordinate for top right point of trapezoid;

4) Y coordinate for top right point of trapezoid;

5) Slope of left side of trapezoid;

6) Slope of right side of trapezoid;

7) Height.

A rectangle, however, is defined within a display list vector command with an opcode followed by only four parameters (each represented by a number of bits) interpreted generally as follows:

1) X coordinate for top left point of rectangle;

2) Y coordinate for top left point of rectangle;

3) Width of rectangle;

4) Height of rectangle.

Therefore, each display list vector command that is converted from a trapezoid to a rectangle reduces the storage requirements for the object.

FIG. 10 shows another embodiment of an exemplary method 1000 for encoding loss into a display list vector command. The method 1000 is generally performed by the display list loss encoder 222 (FIG. 2), and may be considered to be an extension of either of the methods 300 and 400 from FIGS. 3 and 4, respectively. The method 1000 is generally intended to save memory space in a printer 104 by quantizing parameters that define an object in a display list vector command into a reduced bit representation. Object parameters are typically represented by 8 bit representations. An example of an object parameter is an 8 bit representation for the location of an X coordinate of a corner of a rectangle object. Quantizing such vector command parameters into reduced bit representations saves memory on a printer 104 while often having little or no perceivable impact on printed image quality for many documents.

At block 1002 of method 1000, an object parameter in a display list vector command having a first bit representation (e.g., an 8 bit representation) is quantized into a reduced bit representation (e.g., a 7 bit representation). An example of such quantization would be to divide the 8 bit representation of the object parameter by 2. This quantization would result in the object parameter being represented by 7 bits instead of 8 bits, thus reducing the amount of memory needed for storage of a display list vector command.

FIGS. 11, 12 and 13 each show embodiments of exemplary methods for encoding loss into a display list vector command where the vector command defines a trapezoid object using a slope and a set of single bit offsets from the slope. The methods are generally performed by the display list loss encoder 222 (FIG. 2), and may be considered to be an extension of either of the methods 300 and 400 from FIGS. 3 and 4, respectively. The methods are generally intended to save memory space in a printer 104 by manipulating the bit representations for the slope, the single bit offsets for the slope, or both.

The method 1100 of FIG. 11, encodes loss into a display list vector command by manipulating the single bit slope offsets in a trapezoid object. At block 1102, the single bit slope offsets are deleted from the display list vector command describing the trapezoid.

The method 1200 of FIG. 12, also encodes loss into a display list vector command by manipulating the single bit slope offsets in a trapezoid object. At block 1202, the single bit slope offsets are skewed toward zero.

The method 1300 of FIG. 13, encodes loss into a display list vector command by reducing the bit representation used to define the slope of a trapezoid object. At block 1302, the slope bit representation (typically an 8 bit representation) is quantized to a reduced bit representation with the display list vector command. Thus, an 8 bit slope representation may be divided by 2 and stored as a 7 bit representation.

Although the description above uses language that is specific to structural features and/or methodological acts, it is to be understood that the invention defined in the appended claims is not limited to the specific features or acts described. Rather, the specific features and acts are disclosed as exemplary forms of implementing the invention.

Additionally, while one or more methods have been disclosed by means of flow diagrams and text associated with the blocks of the flow diagrams, it is to be understood that the blocks do not necessarily have to be performed in the order in which they were presented, and that an alternative order may result in similar advantages.

1. A processor-readable medium comprising processor-executable instructions configured for:
receiving a page description language (PDL) having drawing commands describing printable objects;
parsing the drawing commands into display list commands; and
encoding loss into the display list commands.

2. A processor-readable medium as recited in claim 1, comprising further processor-executable instructions configured for:
decoding the display list commands into raster data; and
printing the raster data.

3. A processor-readable medium as recited in claim 1, wherein the display list commands are color commands.

4. A processor-readable medium as recited in claim 3, wherein the encoding further comprises quantizing a 24 bit color space in a color command to a reduced bit color space.

5. A processor-readable medium as recited in claim 4, wherein the 24 bit color space is selected from the group comprising:
a 24 bit RGB (red, green, blue) color space; and
a 24 bit CMY (cyan, magenta, yellow) color space.

6. A processor-readable medium as recited in claim 4, wherein the 24 bit color space has an 8 bit, 8 bit, 8 bit coding, and the reduced bit color space has a coding selected from the group comprising:
a 5 bit, 6 bit, 5 bit coding; and
a 6 bit, 7 bit, 4 bit coding.

7. A processor-readable medium as recited in claim 3, wherein the encoding further comprises nonlinearly quantizing a 24 bit color space in a color command to a reduced bit color space.

8. A processor-readable medium as recited in claim 3, wherein the encoding further comprises quantizing a 32 bit color space in a color command to a reduced bit color space.

9. A processor-readable medium as recited in claim 8, wherein the 32 bit color space has an 8 bit, 8 bit, 8 bit, 8 bit coding, and the reduced bit color space has a coding selected from the group comprising:
a 5 bit, 6 bit, 5 bit, 5 bit coding; and
a 5 bit, 5 bit, 6 bit, 5 bit coding.

10. A processor-readable medium as recited in claim 3, wherein the encoding further comprises:
converting a first color space in a color command to a decorrelated color space; and
quantizing the decorrelated color space to a reduced bit decorrelated color space.

11. A processor-readable medium as recited in claim 10, wherein the first color space is selected from a group comprising:
an RGB (red, green, blue);
a CMY (cyan, magenta, yellow) color space; and
a CMYK (cyan, magenta, yellow, black) color space.

12. A processor-readable medium as recited in claim 10, wherein the decorrelated color space is selected from a group comprising:
a YCC color space;
a YIQ color space;
a YUV color space;
an Lab color space; and
an Luv color space.

13. A processor-readable medium as recited in claim 12, wherein the decorrelated color space is a 24 bit decorrelated color space, and the reduced bit decorrelated color space has a coding selected from the group comprising:
a 7 bit, 5 bit, 3 bit coding;
an 8 bit, 6 bit, 6 bit coding; and
a 7 bit, 5 bit, 5 bit coding.

14. A processor-readable medium as recited in claim 3, wherein the encoding further comprises converting a color in a color command to gray if the color is close to gray.

15. A processor-readable medium as recited in claim 14, wherein the converting further comprises:
calculating a difference in color component values of the color;
comparing the difference to a threshold; and
converting the color to gray if the difference does not exceed the threshold.

16. A processor-readable medium as recited in claim 3, wherein the encoding further comprises deleting a current color command if a current color in the current color command is close to a previous color in a most recently preceding color command.

17. A processor-readable medium as recited in claim 16, wherein the deleting further comprises:
calculating a difference between the current color and the previous color;
comparing the difference to a threshold; and
deleting the current color command if the difference does not exceed the threshold.

18. A processor-readable medium as recited in claim 1, wherein the display list commands are vector commands.

19. A processor-readable medium as recited in claim 18, wherein a vector command calls out a trapezoid, the encoding further comprising converting the trapezoid to a rectangle if the trapezoid is close to a rectangle.

20. A processor-readable medium as recited in claim 19, wherein the converting further comprises:
comparing a slope of the trapezoid with a threshold; and
if the slope does not exceed the threshold, changing an operation code in the vector command from a trapezoid to a rectangle.

21. A processor-readable medium as recited in claim 18, wherein the encoding further comprises linearly quantizing parameters within a vector command that define an object specified by the vector command.

22. A processor-readable medium as recited in claim 21, wherein each parameter has an 8 bit representation and the linearly quantizing comprises reducing the 8 bit representation to a reduced bit representation.

23. A processor-readable medium as recited in claim 22, wherein the reducing comprises dividing the 8 bit representation by 2 such that the reduced bit representation for each parameter is a 7 bit representation.

24. A processor-readable medium as recited in claim 18, wherein a vector command calls out a trapezoid and the trapezoid is defined by a slope and a list of single bit offsets from the slope, the encoding further comprising deleting the single bit offsets.

25. A processor-readable medium as recited in claim 18, wherein a vector command calls out a trapezoid and the trapezoid is defined by a slope and a list of single bit offsets from the slope, the encoding further comprising skewing the single bit offsets toward zero.

26. A processor-readable medium as recited in claim 18, wherein a vector command calls out a trapezoid and the trapezoid is defined by a slope and a list of single bit offsets from the slope, the slope having an 8 bit representation, the encoding further comprising linearly quantizing the 8 bit representation to a reduced bit representation.

27. A processor-readable medium as recited in claim 26, wherein the linearly quantizing comprises dividing the 8 bit representation by 2 such that the reduced bit representation for the slope is a 7 bit representation.

28. A processor-readable medium comprising processor-executable instructions configured for:
generating display list commands from a page description language (PDL);
sensing a memory-low condition; and
encoding loss into the display list commands to alleviate the memory-low condition.

29. A processor-readable medium as recited in claim 28, wherein the encoding comprises quantizing a 24 bit color space in a color command into a reduced bit color space.

30. A processor-readable medium as recited in claim 28, wherein the encoding comprises:
converting a 24 bit color space in a color command into a decorrelated color space; and
quantizing the decorrelated color space into a reduced bit decorrelated color space.

31. A processor-readable medium as recited in claim 28, wherein the encoding comprises converting a color in a color command to gray if the color is close to gray.

32. A processor-readable medium as recited in claim 28, wherein the encoding comprises deleting a current color command if a current color in the current color command is close to a previous color in a most recently preceding color command.

33. A processor-readable medium as recited in claim 28, wherein a display list command is a vector command defining a trapezoid and the encoding comprises converting the trapezoid to a rectangle if the trapezoid is close to a rectangle.

34. A processor-readable medium as recited in claim 28, wherein the encoding further comprises linearly quantizing parameters within a vector command that define an object specified by the vector command.

35. A processor-readable medium as recited in claim 28, wherein a vector command calls out a trapezoid and the trapezoid is defined by a slope and a list of single bit offsets from the slope, the encoding further comprising adjusting the single bit offsets.

36. A processor-readable medium comprising processor-executable instructions configured for encoding loss into a display list color command by quantizing a 24 bit color space in the color command to a reduced bit color space.

37. A processor-readable medium as recited in claim 36, wherein the 24 bit color space is an RGB (red, green, blue) color space having an 8 bit, 8 bit, 8 bit coding, and the reduced bit color space is an RGB color space having a coding selected from the group comprising:
a 5 bit, 6 bit, 5 bit coding; and
a 6 bit, 7 bit, 4 bit coding.

38. A processor-readable medium as recited in claim 36, wherein the 24 bit color space is a CMY (cyan, magenta, yellow) color space having an 8 bit, 8 bit, 8 bit coding, and the reduced bit color space is a CMY color space having a coding selected from the group comprising:
a 5 bit, 6 bit, 5 bit coding; and
a 6 bit, 7 bit, 4 bit coding.

39. A processor-readable medium comprising processor-executable instructions configured for:
encoding loss into a display list color command, the encoding comprising converting an RGB (red, green, blue) color space in the color command to a decorrelated color space and quantizing the decorrelated color space to a reduced bit decorrelated color space.

40. A processor-readable medium as recited in claim 39, wherein the decorrelated color space is a 24 bit decorrelated color space, and the reduced bit decorrelated color space has a coding selected from the group comprising:
a 7 bit, 5 bit, 3 bit coding; and
a 7 bit, 5 bit, 5 bit coding.

41. A processor-readable medium comprising processor-executable instructions configured for:
encoding loss into a display list color command, the encoding comprising converting a CMY (cyan, magenta, yellow) color space in the color command to a decorrelated color space and quantizing the decorrelated color space to a reduced bit decorrelated color space.

42. A processor-readable medium comprising processor-executable instructions configured for:
encoding loss into a display list color command, the encoding comprising converting a color in the color command to gray if the color is close to gray.

43. A processor-readable medium comprising processor-executable instructions configured for:
encoding loss into a display list color command, the encoding comprising deleting the color command if a color in the color command is close to a previous color in a most recently preceding color command.

44. A method of saving memory on a printing device, comprising:
receiving page description language (PDL) print data having drawing commands describing printable objects;
parsing the drawing commands into display list commands; and
encoding loss into the display list commands.

45. A method as recited in claim 44, wherein the display list commands are color commands and the encoding further comprises linearly quantizing a 24 bit color space in a color command to a reduced bit color space.

46. A method as recited in claim 44, wherein the display list commands are color commands and the encoding further comprises nonlinearly quantizing a 24 bit color space in a color command to a reduced bit color space.

47. A method as recited in claim 44, wherein the display list commands are color commands and the encoding further comprises converting a color in a color command to gray if the color is close to gray.

48. A method as recited in claim 44, wherein the display list commands are color commands and the encoding further comprises deleting a current color command if a current color in the current color command is close to a previous color in a most recently preceding color command.

49. A method as recited in claim 44, wherein the display list commands are vector commands and a vector command calls out a trapezoid, the encoding further comprising converting the trapezoid to a rectangle if the trapezoid is close to a rectangle.

50. A method as recited in claim 44, wherein the display list commands are vector commands and the encoding further comprises linearly quantizing parameters within a vector command that define an object specified by the vector command.

51. A method as recited in claim 44, wherein the display list commands are vector commands and a vector command calls out a trapezoid defined by a slope and a list of single bit offsets from the slope, the encoding further comprising varying the single bit offsets.

52. A method of introducing loss to display list color commands, comprising quantizing a 24 bit color space in a display list color command to a reduced bit color space, the 24 bit color space having an 8 bit, 8 bit, 8 bit coding, and the reduced bit color space having a coding selected from the group comprising:
a 5 bit, 6 bit, 5 bit coding; and
a 6 bit, 7 bit, 4 bit coding.

53. A method as recited in claim 52, wherein the 24 bit color space is selected from a group comprising:
an RGB (red, green, blue) color space; and
a CMY (cyan, magenta, yellow) color space.

54. A method of introducing loss to display list color commands, comprising:
converting a 24 bit color space in a color command to a decorrelated color space; and
quantizing the decorrelated color space to a reduced bit color space.

55. A method of introducing loss to display list color commands, comprising:
calculating a difference in color component values of a 24 bit color in a display list color command;
comparing the difference to a threshold; and
converting the 24 bit color to gray if the difference does not exceed the threshold.

56. A method of introducing loss to display list color commands, comprising:
calculating a difference between a current color in a current display list color command and a previous color in a preceding display list color command;
comparing the difference to a threshold; and
deleting the current display list color command if the difference does not exceed the threshold.

57. A method of introducing loss to display list vector commands, comprising:
comparing a slope of a trapezoid in a display list vector command with a threshold; and
if the slope does not exceed the threshold, changing an operation code in the display list vector command from a trapezoid to a rectangle.

58. A method of introducing loss to display list vector commands, comprising quantizing parameter bit representations within a display list vector command into reduced bit parameter bit representations.

59. A method of introducing loss to display list vector commands, comprising varying single bit slope offsets in a display list vector command that calls out a trapezoid defined by a slope and a list of single bit slope offsets.

60. A system comprising:
a display list generator to receive PDL (page description language) print data and to generate display list commands describing printable objects from the PDL print data; and
a display list loss encoder to encode loss into the display list commands creating loss-encoded display list data.

61. A system as recited in claim 60, further comprising:
a display list decoder to decode the loss-encoded display list data into raster data; and
a print engine to render the printable objects as hardcopy images on a recording medium.

62. A system as recited in claim 60, further comprising an input device to generate the PDL print data and transfer the PDL print data to a printer.

63. A printer comprising:
a processor;
a memory;
a display list generator stored in the memory and executable on the processor to generate display list commands describing printable objects from PDL (page description language) print data; and
a display list loss encoder stored in the memory and executable on the processor to encode loss into the display list commands creating loss-encoded display list data.

64. A printer as recited in claim 63, further comprising:
a display list decoder stored in the memory and executable on the processor to decode the loss-encoded display list data into raster data; and
a print engine to render the printable objects as hardcopy images on a recording medium.
